(19) United States
(12) Patent Application Publication
(10) Pub. No.: US 2024/0187118 A1
(43) Pub. Date: Jun. 6, 2024

(54) SYNCHRONIZATION OF MULTIPLE SIGNALS WITH AN UNPRECISE REFERENCE CLOCK

(71) Applicant: RTX A/S, Nørresundby (DK)

(72) Inventor: Mads Berre ERIKSEN, Nørresundby (DK)

(21) Appl. No.: 18/550,478

(22) PCT Filed: Mar. 9, 2022
(86) PCT No.: PCT/EP2022/056032

§ 371 Date: Sep. 14, 2023

(30) Foreign Application Priority Data
Mar. 17, 2021 (DK) PA 2021 70121

(51) Int. Cl. H04J 3/06; H04W 56/00

(52) U.S. Cl. CPC H04J 3/0644; H04J 3/0617; H04W 56/0015

(57) ABSTRACT

The invention provides a method for synchronizing timing clocks in wireless communication, e.g. DECT based, between a timing master (P_l) and a timing slave (P_f). The timing master measures (MPD1) a phase offset between its internal clock and a reference clock, e.g. a network clock, e.g. IEEE 1588 over an Ethernet connection. Next, the timing master transmits (TPD1) data indicative of said measured phase offset to the timing slave or timing slaves, which also measure their phase offset between their internal clocks and the reference clock. Next, the timing slave(s) adjust (APD2) their phase offset between their respective internal clocks and the reference clock in response to the received data indicative of measured phase offset from the timing master. Thus, the timing slaves can ensure that they provides the same phase offset between their internal clocks and the reference clock as the timing master. Thus, DECT synchronization can be obtained in spite of a reference clock with a limited precision.

### FIELD OF THE INVENTION

The present invention relates to wireless transmission technology. More specifically, to the field of synchronization of multiple radio modules with precise clocks (deviation below 5 ppm) that need to synchronized against a reference clock which is not precise (deviation of above 100 ppm). Especially, the invention relates to the field of Digital Enhanced Cordless Telecommunication (DECT) based communication of audio.

### BACKGROUND OF THE INVENTION

The present invention seeks to solve the problem of having multiple precise clocks that needs to be synchronized against an unprecise reference clock. E.g. multiple radio modules with precision clocks (deviation below 5 ppm) that need to be synchronized against a network clock with a deviation above 100 ppm.

The audio system is assumed to be synchronized using IEEE 1588. Since the audio clock can have a deviation of up to 200 ppm from the nominal frequency, it cannot be used directly as a reference clock for a DECT based radio module.

### SUMMARY OF THE INVENTION

In a first aspect, the invention provides a method for synchronizing timing clocks in wireless communication between a first wireless device being a timing master (P_l) and a second wireless device being a timing slave (P_f), the method comprising
measuring by the first wireless device (P_l) a phase offset between its internal clock and a reference clock (R), e.g. a network clock,
transmitting by the first wireless device (P_l) data indicative of said measured phase offset to the second wireless device (P_f),
receiving by the second wireless device (P_f) said data indicative of said measured phase offset from the first wireless device (P_l),
measuring by the second wireless device (P_f) a phase offset between its internal clock and the reference clock (R), and
adjusting by the second wireless device (P_f) the phase offset between its internal clock and the reference clock (R) in response to said data indicative of said measured phase offset from the first wireless device (P_l), so as to ensure that the second wireless device (P_f) provides the same phase offset between its internal clock and the reference clock (R) as the phase offset between the internal clock of the first wireless device (P_l) and the reference clock (R).

Such method is advantageous since it allows precise synchronization of two wireless devices, e.g. for DECT synchronization, by the use of an unprecise reference clock, e.g. based on an IEEE 1588 based clock with a deviation of up to 200 ppm.

By use of a clock signal from one common reference clock to which both of the two wireless devices have access, both wireless device can measurement phase offset between this reference clock and their respective internal clocks. The timing master wireless device then transmits its measured phase offset to the slave wireless device, and the slave wireless device then adjusts its internal clock so as to ensure that the phase offset is the same as the phase offset value received from the master wireless device. In this way it is possible to synchronize the internal clocks of the master and slave wireless devices with a high precision even though the common reference clock does not provide a sufficiently high precision. E.g. this allows DECT synchronization based on the reference clock provided by an IEEE 1588 network connection.

Preferably, the first and second wireless devices (P_l, P_f) are arranged to communicate according to an IEEE 1588 compatible protocol.

Preferably, the first and second wireless devices (P_l, P_f) are arranged for wireless communication according to a DECT compatible protocol.

The reference clock is preferably a common reference clock provided to the first and second wireless devices. The reference clock is preferably external to and separate from the first and second wireless devices and providing a common reference clock signal to both of the first and second wireless devices via a network connection, such as an Ethernet network connection.

In a second aspect, the invention provides a wireless device comprising
at least one RF transmitter and receiver circuit connected to an antenna, and
an internal clock, and
   wherein the wireless device is configured to operate as the first or second wireless device according to the method according to the first aspect.

Preferably, the wireless device is configured to switch between operating as the first wireless device and operating as the second wireless device.

Preferably, the wireless device is configured to communicate according to a DECT based protocol.

Preferably, the wireless device is configured for one-way or two-way audio communication.

Preferably, the wireless device is configured for audio communication according to an IEEE 1588 compatible protocol, e.g. being configured for audio communication according to the IEEE 1588 compatible protocol over an Ethernet based network.

The wireless device may especially be one of: a live performance base station, a wireless microphone, a wireless headset, a wireless intercom device, a teleconference device, a wireless audio monitor, and a virtual reality device.

In a third aspect, the invention provides a system comprising at plurality of wireless devices according to the second aspect. Especially, the system is one of: a wireless headset, a wireless mouse, a wireless gaming controller, a wireless keyboard, a wireless microphone, a wireless loudspeaker, a wireless intercom system, a video system, and a Virtual Reality system.

It is appreciated that the same advantages and embodiments described for the first aspect apply as well the further mentioned aspects. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates a block diagram of an embodiment, and

FIG. 2 illustrates steps of a method embodiment.

The figures illustrate specific ways of implementing the present invention and are not to be construed as being limiting to other possible embodiments falling within the scope of the attached claim set.

### DETAILED DESCRIPTION OF THE INVENTION

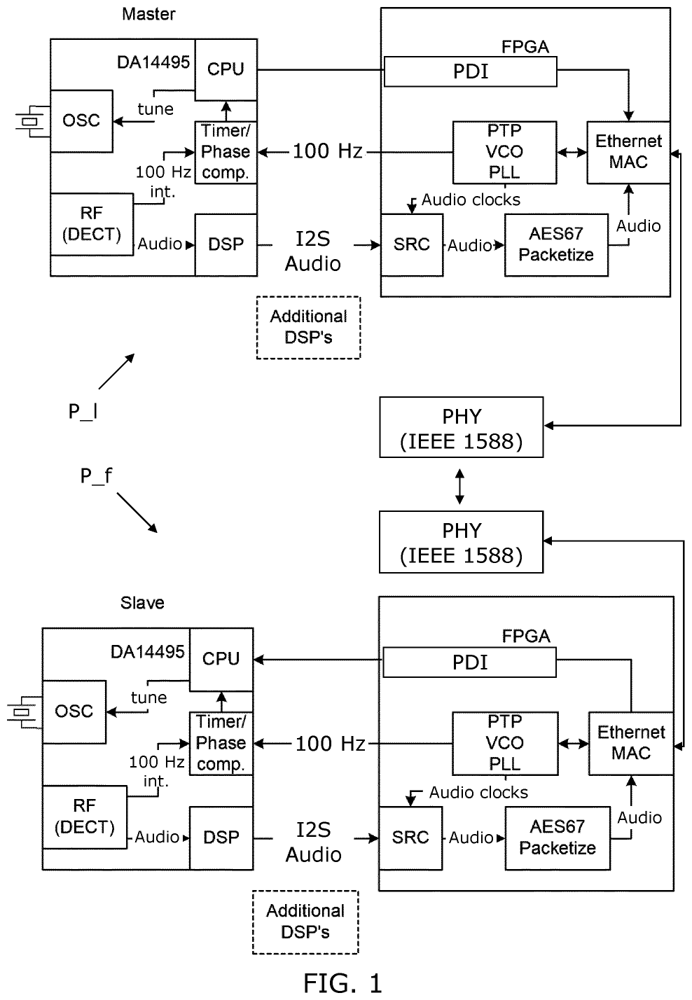

FIG. 1 illustrates a block diagram of an embodiment with a first wireless device P_l operating as a DECT synchronization master (or leader) and an IEEE 1588 audio communication via an Ethernet network connection, and a second wireless device P_f operating as a DECT synchronization slave (or follower). Only two devices P_f, P_l are shown, but in principle almost any number of RU's could be used.

The audio system is assumed to be synchronized using IEEE 1588. Since the audio clock can have a deviation of up to 200 ppm from the nominal frequency, it cannot be used directly as a reference clock for the DECT part. But having a time stamp, which is received by all RU's, may still be useful. E.g. a system could be implemented where one RU is appointed as the DECT master P_l. The DECT master P_l could then measure the timing of the incoming time pulse (based on IEEE 1588 time stamp) relative to its own DECT frame timing and send this timing information, e.g. as phase delay data PDI, to the other RU's P_f in the system.

The other RU's receive the phase delay data PDI and should then adjust their timing/reference-clock to make sure that they achieve the same timing relationship between the time pulse and their local DECT frame timing.

With this method a suitable period between the time pulses must be selected. If the period is too long it may take a long time to get an accurate synchronization and the clocks may drift too much between the time pulses. If the period is too short there may not be enough time to get the timing information from the master RU sent to the slave RU's before the next time pulse is received. This could lead to uncertainty related to which time pulse was the reference and thereby an offset of one (or more) time pulse periods. The minimum time pulse period will therefore depend on how fast the timing information can be communicated over the Ethernet backbone.

In principle the time pulse period does not need to be a fixed period like e.g. 10 ms. It could vary from one interval to the next. But it will probably still be an advantage to have a fixed time interval, perhaps somewhere in the range of 10 to 100 ms. The optimum time interval can be selected according to various conditions.

One device acts as Master, i.e. the one that determines the timing of the DECT system. The other device P_f (or a plurality of devices) act as Slave, because it adjusts its timing to the timing of the master P_l. In the shown embodiment, the master and slave devices P_l, P_f may be identical, but one of the RU's P_l takes the role as the master. The appointment as a master or slave can be predetermined or it can be automatically assigned, e.g. during start-up. In the shown embodiment, the devices P_l, P_f each has an FPGA which handles functions related to the Ethernet interface, including audio transfer and IEEE 1588 timing, sample rate conversion and clock generation for the audio system. However, this may be implemented in other ways than an FPGA.

In the shown embodiment, the FPGA can generate a 100 Hz clock signal, which is derived from the IEEE 1588 timing. It is furthermore assumed that the 100 Hz clock signals in the individual devices P_1, P_f are synchronous, so that the timing difference is less than 1 us and ideally much better than this, e.g. less than 100 ns.

In the DECT part another 100 Hz clock is generated, based on the DECT timing. This is generated, in this embodiment, internally in a DA14495 chip. The DA14495 uses a timer (phase comparator) to measure the timing difference between the 100 Hz from the audio system and the 100 Hz from the DECT system. This is done in all devices P_l, P_f. A suitable timer is available in the DA14495 chip, so it does not have to be implemented in the FPGA. Using the internal timer in the DA14495 means that the CPU in the DA144495 has direct access to the timer information without using e.g. a serial interface to the FPGA to access the information.

The master device P_l will then send information to all slave devices P_f about the timing relationship measured by the master P_l. It will also send DECT multi-frame information, which will be needed if handover is required.

The slave P_f will compare the timing information received from the master P_l and the timing information measured locally. Based on this comparison the slave(s) P_f will adjust their crystal oscillators so that, over time, it will get the same timing as the master P_l. Initially (shortly after power-up) a larger timing jump will be made to allow faster synchronization. Once the devices P_l, P_f have started normal operation they will continuously monitor the timing and adjust the crystal, thereby implementing a software controlled PLL.

The block diagram shows here that an additional DSP's may be preferred. This is only related to the number of audio channels required and has no influence on the synchronization.

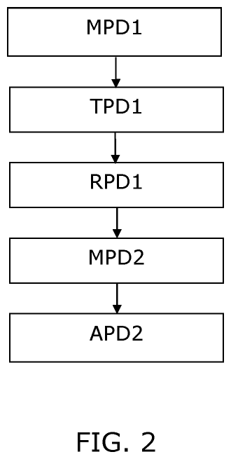

FIG. 2 illustrates steps of a method embodiment, namely a method for synchronizing timing clocks in wireless DECT communication between a first wireless device being a timing master P_l and a second wireless device being a timing slave P_f. First, measuring MPD1 by the first wireless device P_l a phase offset or phase delay between its internal clock and a reference clock, e.g. a network clock which can be rather unprecise, e.g. an IEEE 1588 based clock with a deviation of such as 200 ppm. Next, transmitting TPD1 data indicative of said measured phase offset or phase delay by the first wireless device P_l to the second wireless device P_f, and receiving RPD1 said data indicative of said measured phase offset or phase delay from the first wireless device P_l by the second wireless device P_f. Further, measuring MPD2 by the second wireless device P_f a phase offset between its internal clock and the reference clock.

Finally, adjusting APD2 by the second wireless device P_f the phase offset or phase delay between its internal clock and the reference clock in response to said data indicative of said measured phase offset from the first wireless device P_l. Hereby, the second wireless device P_f can ensure that its internal clock provides the same phase offset or phase delay to the reference clock as the phase offset or phase delay as between the internal clock of the first wireless device P_l and the reference clock. Thus, the master and slave devices P_l, P_f can thus ensure precise DECT synchronization timing in spite of an unprecise reference clock.

To sum up, the invention provides a method for synchronizing timing clocks in wireless communication, e.g. DECT based, between a timing master (P_l) and a timing slave (P_f). The timing master measures (MPD1) a phase offset between its internal clock and a reference clock, e.g. a network clock, e.g. IEEE 1588 over an Ethernet connection. Next, the timing master transmits (TPD1) data indicative of said measured phase offset to the timing slave or timing slaves, which also measure their phase offset between their internal clocks and the reference clock. Next, the timing slave(s) adjust (APD2) their phase offset between their respective internal clocks and the reference clock in response to the received data indicative of measured phase offset from the timing master. Thus, the timing slaves can ensure that they provides the same phase offset between their internal clocks and the reference clock as the timing master. Thus, DECT synchronization can be obtained in spite of a reference clock with a limited precision.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for synchronizing timing clocks in wireless communication between a first wireless device being a timing master and a second wireless device being a timing slave, the method comprising
measuring by the first wireless device a phase offset between its internal clock and a reference clock,
transmitting by the first wireless device data indicative of said measured phase offset to the second wireless device,
receiving by the second wireless device said data indicative of said measured phase offset from the first wireless device,
measuring by the second wireless device a phase offset between its internal clock and the reference clock, and
adjusting by the second wireless device the phase offset between its internal clock and the reference clock in response to said data indicative of said measured phase offset from the first wireless device, so as to ensure that the second wireless device provides the same phase offset between its internal clock and the reference clock as the phase offset between the internal clock of the first wireless device and the reference clock.

2. The method according to claim 1, wherein the first and second wireless devices are arranged to communicate according to an IEEE 1588 compatible protocol.

3. The method according to claim 1, wherein the first and second wireless devices are arranged for wireless communication according to a DECT compatible protocol.

4. The method according to claim 1, wherein the reference clock is a common reference clock for both of the first and second wireless devices via a network connection, such as an Ethernet network connection.

5. The method according to claim 4, wherein the common reference clock is external to the first and second wireless devices and providing a common reference clock signal to both of the first and second wireless devices via a network connection, such as an Ethernet network connection.

6. A wireless device comprising
at least one RF transmitter and receiver circuit connected to an antenna, and
an internal clock, and
wherein the wireless RF device is configured to operate as the first or second wireless device according to the method according to claim 1.

7. The wireless device according to claim 6, wherein the wireless device is configured to switch between operating as the first wireless device and operating as the second wireless device.

8. The wireless device according to claim 6, being configured to communicate according to a DECT based protocol.

9. The wireless device according to claim 8, being configured for one-way or two-way audio communication, such as configured for audio communication according to an IEEE 1588 compatible protocol.

10. The wireless device according to claim 9, being configured for audio communication according to the IEEE 1588 compatible protocol over an Ethernet based network.

11. The wireless device according to claim 6, being one of: a live performance base station, a wireless microphone, a wireless headset, a wireless intercom device, a teleconference device, a wireless audio monitor, and a virtual reality device.

12. A system comprising at plurality of wireless devices according to claim 6.

13. The system according to claim 12, wherein the system is one of: a wireless headset, a wireless mouse, a wireless gaming controller, a wireless keyboard, a wireless microphone, a wireless loudspeaker, a wireless intercom system, a video system, and a Virtual Reality system.
